(19) United States
(12) Patent Application Publication
(10) Pub. No.: US 2021/0153290 A1
(43) Pub. Date: May 20, 2021

(54) EVENT TRIGGERED DISABLING OF 5G NETWORK CONNECTION

(71) Applicant: T-Mobile USA, Inc., Bellevue, WA (US)

(72) Inventors: Syed Toaha Ahmad, Renton, WA (US); Hsin-Fu Henry Chiang, Bellevue, WA (US); Ming Shan Kwok, Seattle, WA (US); Adnan Rahat, Renton, WA (US); Muhammad Tawhidur Rahman, Bellevue, WA (US); Wafik Abdel Shahid, Kenmore, WA (US)

(21) Appl. No.: 17/097,311

(22) Filed: Nov. 13, 2020

Related U.S. Application Data
(60) Provisional application No. 62/936,090, filed on Nov. 15, 2019.

(51) Int. Cl. H04W 76/30

(52) U.S. Cl. CPC H04W 76/30; H04W 84/12

(57) ABSTRACT

A standalone mobile device that is not configured to handle voice over 5G is configured to automatically disable its 5G NR radio such that the NR radio is inoperable with respect to 5G networks, e.g., the mobile device cannot connect to a NR base station. The disabling of the mobile device's ability to connect to a 5G network may be event triggered, where an example of the event may be that the mobile device is handling a VoWiFi call. When the mobile device is handling a VoWiFi call and the VoWiFi call needs to be handed over to a cellular network, then the mobile device may perform the handover procedure of the VoWiFi call to an LTE network rather than first attempting to hand the VoWiFi call over to a 5G network via an EPS-FB procedure. When the call ends, the mobile device may re-enable its NR radio.

### CROSS-REFERENCE TO RELATED APPLICATION

This application claims priority to a co-pending, commonly owned U.S. Provisional Patent Application No. 62/936,090 filed on Nov. 15, 2019, and titled “Event Triggered Disabling of 5g Network Connection,” which is herein incorporated by reference in its entirety.

### BACKGROUND

Cellular communication devices use network radio access technologies to communicate wirelessly with geographically distributed cellular base stations. Long-Term Evolution (LTE) is an example of a widely implemented radio access technology that is used in 4^{th} Generation (4G) communication systems. New Radio (NR) is a newer radio access technology that is used in 5^{th} Generation (5G) communication systems. Standards for LTE and NR radio access technologies have been developed by the 3rd Generation Partnership Project (3GPP) for use by wireless communication carriers.

In the early development of the Fifth Generation (5G) New Radio (NR) wireless communication network, the network and the user equipment (UE), generally in the form of a mobile device, may not be able to deploy a native voice solution to meet the certification or network operator's mean option score (MOS) for voice-over-internet protocol (VoIP). The Third Generation Partnership Project (3GPP) standard provides some fallback procedures to work around the native-voice challenges. One such fallback procedure is a Radio Access Technology (RAT) fallback solution referred to as Evolved Packet System Fallback (EPS-FB) procedure. However, the EPS-FB procedure creates a user experience problem during handover of a voice-over WiFi (VoWiFi) call to voice-over 5G. The problem arises when the UE is a standalone (SA) device but is not configured for voice-over 5G. Thus, during the EPS-FB procedure, when a voice call needs to be handed over from VoWiFi to a cellular system for handling of the voice call, the EPS-FB procedure involves attempting to handover the VoWiFi call to the 5G network. However, since the UE is not configured for calls over 5G, the 5G network must then hand the voice call over to a Long-Term Evolution (LTE) wireless communication network. This can result in approximately a four to five and one-half second period of silence due to the EPS-FB procedure handing over the VoWiFi call to the 5G network, which then hands the voice call over to the LTE network.

While a user of the UE may manually disable or downgrade and then re-enable or upgrade the ability of the UE, e.g., a 5G NR radio of the UE, to connect to a 5G NR base station prior to and after participating in a VoWiFi call, this requires the user to continually disable and then re-enable the UE for connecting to a 5G NR base station prior to and after participating in a VoWiFi call. This is not practical as it is tedious and also requires the user to remember such disabling and re-enabling the ability of the UE to connect to a 5G NR base station prior to and after participating in a VoWiFi call.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram of a wireless communication network configured to implement VoWiFi voice calls and voice calls using a cellular network

FIG. 2 is a flow diagram illustrating an example method that may be performed by components of a mobile device in the wireless communication network to disable a NR radio of the mobile device.

FIG. 3 is a block diagram of an example computing device that may be used to implement various functionality described herein.

FIG. 4 is a block diagram of an example cellular communication device.

### DETAILED DESCRIPTION

Described herein are techniques and architecture for automatically disabling or downgrading a Fifth Generation (5G) NR radio (referred to herein as NR radio) of a mobile device such that the NR radio is inoperable with respect to 5G networks. The disabling of the mobile device's ability to connect to a 5G network may be event triggered, where an example of the event may be that the mobile device is handling a voice call over WiFi, e.g., a VoWiFi call event. Examples of the VoWiFi call event trigger may include originating a VoWiFi call, receiving a VoWiFi call, and a handover via call-continuity from voice-over LTE (VoLTE).

In particular, when a standalone (SA) mobile device is handling a VoWiFi call, the NR radio may be downgraded to not operate over a 5G NR connection, e.g., the mobile device cannot connect to a 5G NR base station (referred to herein as NR base station). Thus, if the VoWiFi call needs to be handed over to a cellular network, e.g., the quality provided by the WiFi connection is diminished or diminishing, then the mobile device may perform the handover procedure of the VoWiFi call to an LTE network, e.g., the voice call may be handed over and handled by an LTE base station.

In configurations, when the voice call ends, the NR radio may be upgraded or enabled to once again make connections to a NR base station. For example, if the VoWiFi call event ends, e.g., the voice call is terminated or ends, then the NR radio may be enabled to maintain connection to a NR base station, e.g., the mobile device may connect to a NR base station for additional user-plane bandwidth of the mobile device. If the voice call is being handled by a connection to an LTE base station, then when the voice call is terminated or ends, the NR radio may be upgraded or enabled to make connections to a NR base station.

In configurations, the downgrading of the NR radio from being able to make NR radio connections to a NR base station to not being able to make such NR radio connections to a NR base station may be further based on additional functional events. For example, a quality of service (QoS) threshold event may also be included. For example, when the mobile device is handling a VoWiFi call, the downgrading of the NR radio may not automatically occur until the QoS threshold is met, e.g., a minimum threshold for QoS is no longer being maintained. Upon an occurrence of the QoS threshold no longer being met, then the NR radio may be downgraded from having the ability to connect to a NR base station. In configurations, the QoS threshold may be based on one or more of signaling received signal strength indicator (RSSI), packet loss, latency, etc. The QoS threshold event allows for avoiding the need to disable and enable the NR radio for NR connections when the QoS indicates that it is unlikely that the VoWiFi call will need to be handed over to a cellular network.

In configurations, an additional event may include a sudden QoS indicator value drop event. For example, when the mobile device is handling a VoWiFi call, if the QoS indicator value drop event occurs, then the NR radio of the mobile device may be downgraded from being able to make NR base station connections. The QoS indicator value drop event may relate to the QoS suddenly or rapidly deteriorating, e.g., the mobile device may be moving away from the WiFi connection point. Upon the occurrence of the sudden QoS indicator value drop event, the NR radio may be disabled with respect to its ability to make connections to a NR base station. Examples of QoS indicator values may include a value of signaling RSSI, an increased percentage of packet loss, an increase in time of latency, etc. The QoS indicator value drop event allows for avoiding the need to disable and enable the NR radio for NR connections until the QoS indicates that it is likely that the VoWiFi call will need to be handed over to a cellular network.

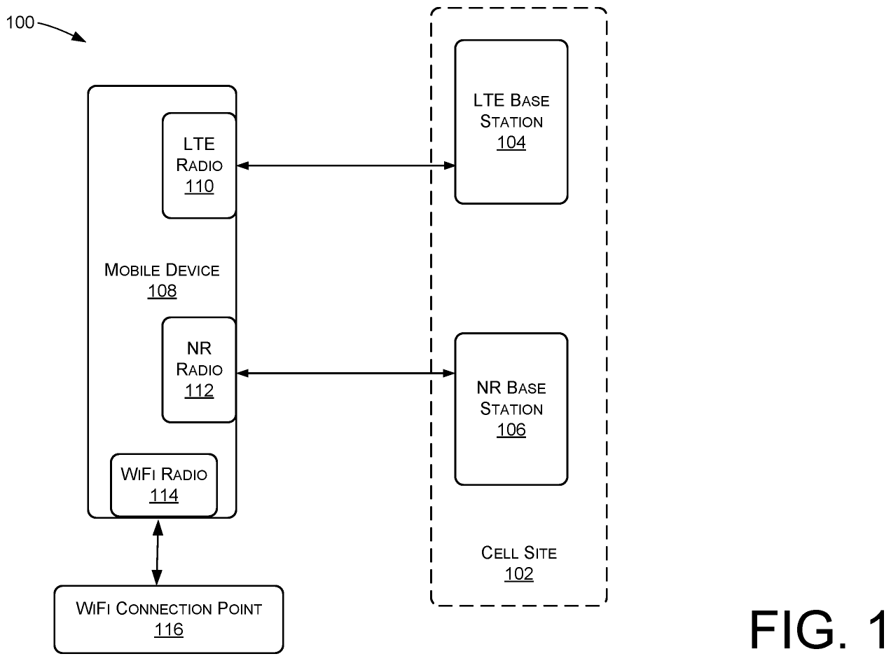

FIG. 1 illustrates relevant high-level components of a wireless communication network or system 100 (system 100 herein) in which the described techniques may be implemented. The components shown in FIG. 1 may be used to implement VoWiFi voice calls and voice calls using a cellular network. It is to be understood that other functions may be implemented by the system 100 and its components.

The system 100 includes a cell site 102, which may be one of many such cell sites. The cell site 102 includes cellular base stations to support both LTE and NR communications. More specifically, the cell site 102 has an LTE base station 104 such as used in 4G cellular networks, and a NR base station 106 such as used in NR cellular networks. An LTE base station is often referred to as an eNodeB. A NR base station is often referred to as a gNodeB. An eNodeB is a base station that implements 4G LTE radio access technologies. A gNodeB is a base station that implements NR radio access technologies.

The system 100 supports multiple cellular communication devices or mobile devices, of which a single mobile device 108 is shown in FIG. 1. The mobile device 108 is often referred to as a User Equipment (UE) in communication systems such as this.

The mobile device 108 may comprise any of various types of cellular communication devices that are capable of wireless data and/or voice communications, including smartphones and other mobile devices, “Internet-of-Things” (IoT) devices, smart home devices, computers, wearable devices, entertainment devices, industrial control equipment, etc. In configurations, the mobile device 108 may be configured as a standalone (SA) device.

The mobile device 108 includes an LTE radio 110 and a NR radio 112, as well as associated components not shown, which communicate with the LTE base station 104 and the NR base station 106, respectively. The LTE radio 110 and its associated logic implements 4G LTE communication protocols. The NR radio 112 and its associated logic implements 5GNR communication protocols. The mobile device 108 also includes a WiFi radio 114. The WiFi radio 114 and its associated logic implements WiFi communication protocols. The system 100 also includes a WiFi connection point 116 for connecting the mobile device 108 to the system 100 via WiFi.

During use, the mobile device 108 communicates with the system 100 through the base stations 104 and 106 of the cell site 102. The mobile device 108 may select and use base stations of different cell sites 102 as the mobile device 108 moves from location to location. Additionally, the mobile device 108 may communicate with the system 100 via the WiFi radio and the WiFi connection point 116 when the mobile device 108 is within range of the WiFi communication point 116.

In configurations, the mobile device 108 is configured as a SA device but is not configured for voice-over 5G, e.g., the mobile device 108 is not configured to handle voice calls via the NR radio 112 and the NR base station 106. Thus, when the mobile device 108 is handling a VoWiFi call via the WiFi radio 114 and the WiFi connection point 116 (e.g., the mobile device 108 has received or initiated a voice call via the WiFi connection point 116, or a voice call has been handed over from VoLTE), the NR radio 112 may be downgraded to not operate over a 5G NR connection, e.g., a configuration setting of the mobile device may be changed so that the NR radio 112 is disabled and cannot connect to the NR base station 106. Thus, if the VoWiFi call needs to be handed over to a cellular network, e.g., the quality provided by the WiFi connection point 116 is diminished or diminishing (e.g., the mobile device 108 is moving away from the WiFi connection point 116), then the mobile device 108 may perform a handover procedure of the VoWiFi call to the LTE base station 104 as opposed to the NR base station 106 since the NR radio 112 is disabled and the mobile device 108 will handle the call via the LTE radio 110.

In configurations, when the voice call is terminated or ends, the NR radio 112 may be upgraded or enabled to once again make connections to the NR base station 106. For example, if the VoWiFi call event ends, e.g., the voice call ends, then the NR radio 112 may be enabled to maintain connection to the NR base station 106, e.g., the configuration setting of the mobile device may be changed so that the NR radio 112 is enabled and can connect to the NR base station 106 for additional user-plane bandwidth of the mobile device 108. If the voice call is currently being handled by the LTE radio 110 via a connection to the LTE base station 104, then when the voice call ends, the NR radio 112 may be upgraded or enabled to make connections to the NR base station 106.

In configurations, the downgrading of the NR radio 112 from being able to make NR radio connections to the NR base station 106 to not being able to make such NR radio connections to the NR base station 106 may be further based on additional functional events. For example, a quality of service (QoS) threshold event may also be included. When the mobile device 108 is handling a VoWiFi call via the WiFi radio 114 and the WiFi connection point 116, the downgrading of the NR radio 112 may not automatically occur until the QoS threshold is met, e.g., a minimum threshold for QoS is no longer being maintained. Upon an occurrence of the QoS threshold no longer being met, then the NR radio 112 may be downgraded from having the ability to connect to the NR base station 112. In configurations, the QoS threshold may be based on one or more of signaling received signal strength indicator (RSSI), packet loss, latency, etc. The QoS threshold event allows for avoiding the need to disable and enable the NR radio 112 for NR connections when the QoS indicates that it is unlikely that the VoWiFi call will need to be handed over to a cellular network, e.g., the LTE base station 104 or the NR base station 106.

In configurations, an additional event may include a sudden QoS indicator value drop event. For example, when the mobile device 108 is handling a VoWiFi call via the WiFi radio 114 and the WiFi connection point 116, if the QoS indicator value drop event occurs, then the NR radio 112 of the mobile device 108 may be downgraded from being able to make NR base station 106 connections. The QoS indicator value drop event may relate to the QoS suddenly or rapidly deteriorating, e.g., the mobile device 108 may be moving away from the WiFi connection point 116. Upon the occurrence of the sudden QoS indicator value drop event, the NR radio 112 may be disabled with respect to its ability to make connections to the NR base station 106. Examples of QoS indicator values may include a value of signaling RSSI, an increased percentage of packet loss, an increase in time of latency, etc. The QoS indicator value drop event allows for avoiding the need to disable and enable the NR radio 112 for NR connections until the QoS indicates that it is likely that the VoWiFi call will need to be handed over to a cellular network.

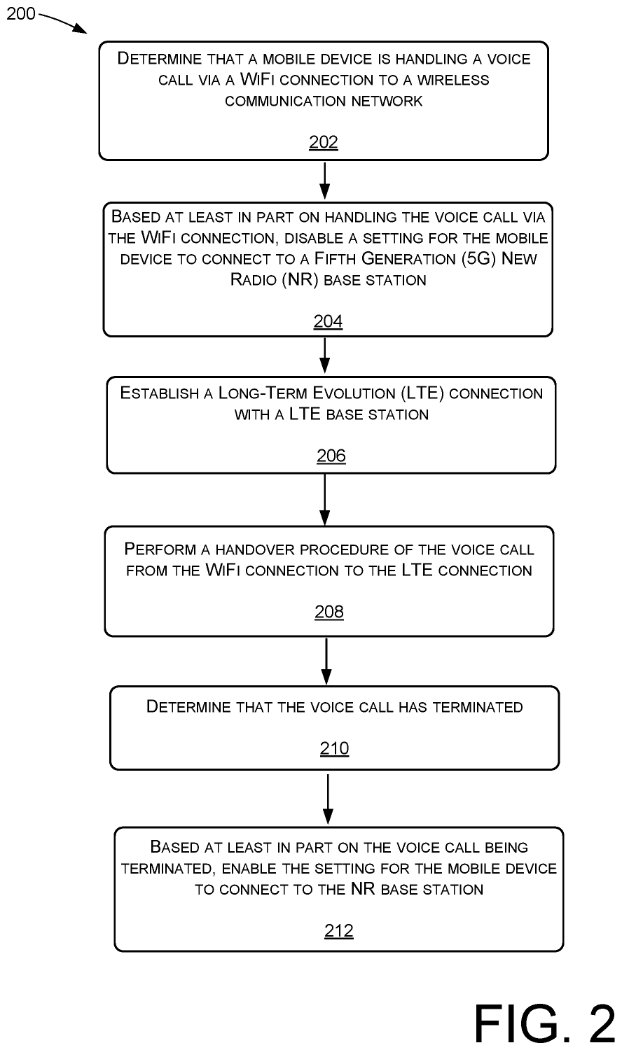

FIG. 2 is a flow diagram of an illustrative process that may be implemented within or in association with the wireless communication system 100. This process (as well as other processes described throughout) is illustrated as a logical flow graph, each operation of which represents a sequence of operations that can be implemented in hardware, software, or a combination thereof. In the context of software, the operations represent computer-executable instructions stored on one or more tangible computer-readable storage media that, when executed by one or more processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Furthermore, while the architectures and techniques described herein have been described with respect to wireless networks and mobile devices, the architectures and techniques are equally applicable to processor(s) and processing cores in other environments and computing device.

FIG. 2 illustrates an example method 200 that may be performed by components of a mobile device, e.g., mobile device 108, to disable a NR radio of the mobile device, e.g., NR radio 112. At block 202, it is determined that the mobile device is handling a voice call via a WiFi connection to a wireless communication network. For example, it may be determined that the mobile device 108 is handling a VoWiFi call via the WiFi radio 114 and the WiFi connection point 116 and the system 100.

At block 204, based at least in part on handling the voice call via the WiFi connection, a setting for the mobile device to connect to a Fifth Generation (5G) New Radio (NR) base station is disabled. For example, based at least in part on the VoWiFi call, the NR radio 112 may be disabled.

At block 206, a Long-Term Evolution (LTE) connection is established with a LTE base station. For example, the mobile device 108 may connect with the LTE base station 104 via the LTE radio 110.

At block 208, a handover procedure of the voice call from the WiFi connection to the LTE connection is performed. For example, the voice call may be handed over from the WiFi connection point 116 to the LTE base station 104.

At block 210, it is determined that the voice call has terminated. At block 212, based at least in part on the voice call being terminated, the setting for the mobile device to connect to the NR base station is enabled. For example, based at least in part on the voice call being terminated, the NR radio 112 of the mobile device 108 may be enabled to allow the mobile device 108 to connect to the NR base station 106.

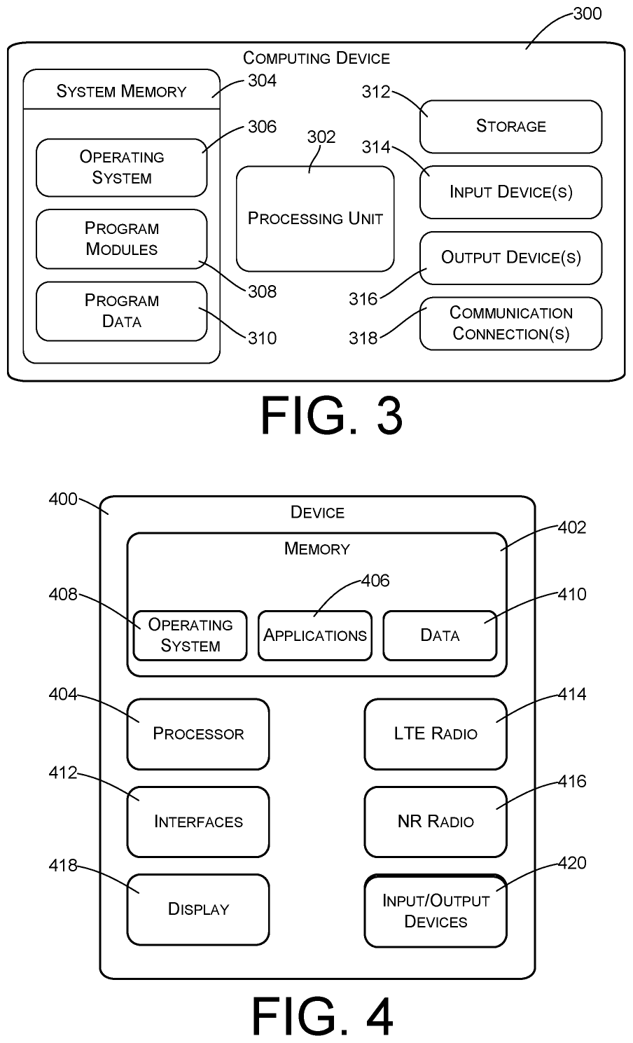

FIG. 3 is a block diagram of an illustrative computing device 300 that may be used to implement various components of a cellular communication system, such as servers, routers, gateways, administrative components, etc. One or more computing devices 300 may be used to implement each of the base stations 104 and 106, for example.

In various embodiments, the computing device 300 may include at least one processing unit 302 and system memory 304. Depending on the exact configuration and type of computing device, the system memory 304 may be volatile (such as RAM), non-volatile (such as ROM, flash memory, etc.) or some combination of the two. The system memory 304 may include an operating system 306, one or more program modules 308, and may include program data 310.

The computing device 300 may also include additional data storage devices (removable and/or non-removable) such as, for example, magnetic disks, optical disks, or tape. Such additional storage devices are illustrated in FIG. 3 as storage 312.

Non-transitory computer storage media of the computing device 300 may include volatile and nonvolatile, removable and non-removable media implemented in any method or technology for storage of information, such as computer readable instructions, data structures, program modules, or other data. The system memory 304 and storage 312 are all examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 300. Any such non-transitory computer-readable storage media may be part of the computing device 300.

In various embodiment, any or all of the system memory 304 and storage 312 may store programming instructions which, when executed, implement some or all of the function functionality described above as being implemented by the base stations 104 and 106.

The computing device 300 may also have input device(s) 314 such as a keyboard, a mouse, a touch-sensitive display, voice input device, etc. Output device(s) 316 such as a display, speakers, a printer, etc., may also be included. The computing device 300 may also contain communication connections 318 that allow the device to communicate with other computing devices.

FIG. 4 illustrates high-level components of an example cellular communication device 400 that may be used to implement the techniques described herein. The device 400 is an example of a mobile device 108 as illustrated in FIG. 1. FIG. 4 shows only basic, high-level components of the device 400.

The device 400 may include memory 402 and a processor 404. The memory 402 may include both volatile memory and non-volatile memory. The memory 402 can also be described as non-transitory computer-readable media or machine-readable storage memory and may include removable and non-removable media implemented in any method or technology for storage of information, such as computer executable instructions, data structures, program modules, or other data. Additionally, in some embodiments the memory 402 may include a SIM (subscriber identity module), which is a removable smart card used to identify a user of the device 400 to a service provider network.

The memory 402 may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information. The memory 402 may in some cases include storage media used to transfer or distribute instructions, applications, and/or data. In some cases, the memory 402 may include data storage that is accessed remotely, such as network-attached storage that the device 400 accesses over some type of data communication network.

The memory 402 stores one or more sets of computer-executable instructions (e.g., software) such as programs that embody operating logic for implementing and/or performing desired functionality of the device 400. The instructions may also reside at least partially within the processor 404 during execution thereof by the device 400. Generally, the instructions stored in the computer-readable storage media may include various applications 406 that are executed by the processor 404, an operating system (OS) 408 that is also executed by the processor 404, and data 410.

In some embodiments, the processor(s) 404 is a central processing unit (CPU), a graphics processing unit (GPU), both CPU and GPU, or other processing unit or component known in the art. Furthermore, the processor(s) 404 may include any number of processors and/or processing cores. The processor(s) 404 is configured to retrieve and execute instructions from the memory 402.

The device 400 may have interfaces 412, which may comprise any sort of interfaces known in the art. The interfaces 412 may include any one or more of an Ethernet interface, wireless local-area network (WLAN) interface, a near field interface, a DECT chipset, or an interface for an RJ-11 or RJ-45 port. A wireless LAN interface can include a WiFi interface or a Wi-Max interface, or a Bluetooth interface that performs the function of transmitting and receiving wireless communications. The near field interface can include a Bluetooth® interface or radio frequency identifier (RFID) for transmitting and receiving near field radio communications via a near field antenna. For example, the near field interface may be used for functions, as is known in the art, such as communicating directly with nearby devices that are also, for instance, Bluetooth® or RFD enabled.

The device 400 may also have an LTE radio 414 and a NR radio 416, which may be used as described above for implementing connectivity in conjunction with LTE and NR base stations as described above.

The device 400 may have a display 418, which may comprise a liquid crystal display or any other type of display commonly used in telemobile devices or other portable devices. For example, the display 418 may be a touch-sensitive display screen, which may also act as an input device or keypad, such as for providing a soft-key keyboard, navigation buttons, or the like.

The device 400 may have input and output devices 420. These devices may include any sort of output devices known in the art, such as a display (already described as display 418), speakers, a vibrating mechanism, or a tactile feedback mechanism. Output devices may also include ports for one or more peripheral devices, such as headphones, peripheral speakers, or a peripheral display. Input devices may include any sort of input devices known in the art. For example, the input devices may include a microphone, a keyboard/keypad, or a touch-sensitive display (such as the touch-sensitive display screen described above). A keyboard/keypad may be a push button numeric dialing pad (such as on a typical telemobile device), a multi-key keyboard (such as a conventional QWERTY keyboard), or one or more other types of keys or buttons, and may also include a joystick-like controller and/or designated navigation buttons, or the like.

Although features and/or methodological acts are described above, it is to be understood that the appended claims are not necessarily limited to those features or acts. Rather, the features and acts described above are disclosed as example forms of implementing the claims.

What is claimed is:

1. A method performed by a mobile device configured to operate as a stand-alone (SA) device, the method comprising:
handling, by the mobile device, a call as a voice-over WiFi (VoWiFi) call event; and
based at least in part on the VoWiFi call event, disabling, by the mobile device during the VoWiFi call event, a NR radio of the mobile device with respect to New Radio (NR) radio access technology.

2. The method of claim 1, further comprising:
performing, by the mobile device, a handover procedure of the call from the VoWiFi call event to a cellular call event handled by Long-Term Evolution (LTE) radio access technology.

3. The method of claim 1, further comprising:
upon ending of the call, enabling, by the mobile device, the NR radio of the mobile device with respect to NR radio access technology.

4. The method of claim 1, wherein disabling, by the mobile device during the VoWiFi call event, the NR radio of the mobile device with respect to NR radio access technology is further based at least in part on a WiFi Quality of Service (QoS) threshold.

5. The method of claim 4, wherein the WiFi QoS threshold is based on one or more of Received Signal Strength Indicator (RSSI), packet loss, or latency.

6. The method of claim 1, wherein disabling, by the mobile device during the VoWiFi call event, the NR radio of the mobile device with respect to NR radio access technology is further based at least in part on a Quality of Service (QoS) indicator drop threshold.

7. The method of claim 6, wherein the QoS indicator drop threshold is based on one or more of a value of signaling Received Signal Strength Indicator (RSSI), a percentage increase of packet loss, or an increase in latency.

8. An apparatus comprising:
one or more processors; and
a non-transitory storage medium comprising instructions stored thereon, the instructions being executable by the one or more processors to cause the processors to perform one or more actions comprising:
handling a call as a voice-over WiFi (VoWiFi) call event; and
based at least in part on the VoWiFi call event, disabling, during the VoWiFi call event, a NR radio of a mobile device with respect to New Radio (NR) radio access technology.

9. The apparatus of claim 8, wherein the actions further comprise:
performing a handover procedure of the call from the VoWiFi call event to a cellular call event handled by Long-Term Evolution (LTE) radio access technology.

10. The apparatus of claim 8, wherein the actions further comprise:
upon ending of the call, enabling the NR radio of the mobile device with respect to NR radio access technology.

11. The apparatus of claim 8, wherein disabling, during the VoWiFi call event, the NR radio of the mobile device with respect to NR radio access technology is further based at least in part on a WiFi Quality of Service (QoS) threshold.

12. The apparatus of claim 11, wherein the WiFi QoS threshold is based on one or more of Received Signal Strength Indicator (RSSI), packet loss, or latency.

13. The apparatus of claim 8, wherein disabling, during the VoWiFi call event, the NR radio of the mobile device with respect to NR radio access technology is further based at least in part on a Quality of Service (QoS) indicator drop threshold.

14. The apparatus of claim 13, wherein the QoS indicator drop threshold is based on one or more of a value of signaling Received Signal Strength Indicator (RSSI), a percentage increase of packet loss, or an increase in latency.

15. A method comprising:
determining that a mobile device is handling a voice call via a WiFi connection to a wireless communication network;
disabling, based at least in part on handling the voice call via the WiFi connection, a setting for the mobile device to connect to a Fifth Generation (5G) New Radio (NR) base station;
establishing a Long-Term Evolution (LTE) connection with a LTE base station;
performing a handover procedure of the voice call from the WiFi connection to the LTE connection;
determining that the voice call has terminated; and
enabling, based at least in part on the voice call being terminated, the setting for the mobile device to connect to the NR base station.

16. The method of claim 15, wherein disabling the setting for the mobile device to connect to the NR base station is further based at least in part on a WiFi Quality of Service (QoS) threshold.

17. The method of claim 16, wherein the WiFi QoS threshold is based on one or more of Received Signal Strength Indicator (RSSI), packet loss, or latency.

18. The method of claim 15, wherein disabling the setting for the mobile device to connect to the NR base station is further based at least in part on a Quality of Service (QoS) indicator drop threshold.

19. The method of claim 18, wherein the QoS indicator drop threshold is based on one or more of a value of signaling Received Signal Strength Indicator (RSSI), a percentage increase of packet loss, or an increase in latency.
